(19) United States
(12) Patent Application Publication
(10) Pub. No.: US 2023/0413197 A1
(43) Pub. Date: Dec. 21, 2023

(54) DOPPLER SHIFT FREQUENCY DETERMINATION AND COMPENSATION

(71) Applicant: LENOVO (BEIJING) LIMITED, Beijing (CN)

(72) Inventors: Chenxi Zhu, Fairfax, VA (US); Bingchao Liu, Fairfax, VA (US)

(21) Appl. No.: 18/248,354

(22) PCT Filed: Oct. 9, 2020
(86) PCT No.: PCT/CN2020/119947

§ 371 Date: Apr. 7, 2023

(51) Int. Cl. H04W 56/00; H04L 5/00

(52) U.S. Cl. CPC H04W 56/001; H04L 5/0051; H04L 5/0035

(57) ABSTRACT

Apparatuses, methods, and systems are disclosed for Doppler shift frequency determination and compensation. One method (600) includes transmitting (602), from a first transmission reception point, a first reference signal to a user equipment on a first frequency. In certain embodiments, the method (600) includes receiving (604), at the first transmission reception point, a second reference signal from the user equipment on a second frequency, wherein the second frequency is based on a third frequency on which the user equipment received the first reference signal. In some embodiments, the method (600) includes determining (606) a first Doppler shift frequency using the first frequency and the second frequency.

### FIELD

The subject matter disclosed herein relates generally to wireless communications and more particularly relates to Doppler shift frequency determination and compensation.

### BACKGROUND

The following abbreviations are herewith defined, at least some of which are referred to within the following description: Third Generation Partnership Project (“3GPP”), 5G QoS Indicator (“5QI”), Acknowledge Mode (“AM”), Aperiodic (“AP”), Backhaul (“BH”), Broadcast Multicast (“BM”), Buffer Occupancy (“BO”), Base Station (“BS”), Buffer Status Report (“BSR”), Bandwidth (“BW”), Bandwidth Part (“BWP”), Carrier Aggregation (“CA”), Code Block Group (“CBG”), CBG Flushing Out Information (“CBGFI”), CBG Transmission Information (“CBGTI”), Component Carrier (“CC”), Control Channel Element (“CCE”), Code Division Multiplexing (“CDM”), Control Element (“CE”), Coordinated Multipoint (“CoMP”), Categories of Requirements (“CoR”), Control Resource Set (“CORESET”), Cyclic Prefix (“CP”), Cyclic Prefix OFDM (“CP-OFDM”), Cyclic Redundancy Check (“CRC”), CSI-RS Resource Indicator (“CRI”), Cell RNTI (“C-RNTI”), Channel State Information (“CSI”), CSI IM (“CSI-IM”), CSI RS (“CSI-RS”), Channel Quality Indicator (“CQI”), Central Unit (“CU”), Codeword (“CW”), Downlink Assignment Index (“DAI”), Downlink Control Information (“DCI”), Downlink Feedback Information (“DFI”), Downlink (“DL”), Discrete Fourier Transform Spread OFDM (“DFT-s-fOFDM”), Demodulation Reference Signal (“DMRS” or “DM-RS”), Data Radio Bearer (“DRB”), Dedicated Short-Range Communications (“DSRC”), Distributed Unit (“DU”), Enhanced Mobile Broadband (“eMBB”), Evolved Node B (“eNB”), Enhanced Subscriber Identification Module (“eSIM”), Enhanced (“E”), Frequency Division Duplex (“FDD”), Frequency Division Multiplexing (“FDM”), Frequency Division Multiple Access (“FDMA”), Frequency Range (“FR”), 450 MHz-6000 MHz (“FR1”), 24250 MHz-52600 MHz (“FR2”), Hybrid Automatic Repeat Request (“HARQ”), High-Definition Multimedia Interface (“HDMI”), High-Speed Train (“HST”), Integrated Access Backhaul (“IAB”), Identity or Identifier or Identification (“ID”), Information Element (“IE”), Interference Measurement (“IM”), International Mobile Subscriber Identity (“IMSI”), Internet-of-Things (“IoT”), Internet Protocol (“IP”), Joint Transmission (“JT”), Level 1 (“L1”), L1 RSRP (“L1-RSRP”), L1 SINR (“L1-SINR”), Logical Channel (“LCH”), Logical Channel Group (“LCG”), Logical Channel ID (“LCID”), Logical Channel Prioritization (“LCP”), Layer Indicator (“LI”), Least-Significant Bit (“LSB”), Long Term Evolution (“LTE”), Levels of Automation (“LoA”), Medium Access Control (“MAC”), Modulation Coding Scheme (“MCS”), Multi DCI (“M-DCI”), Master Information Block (“MIB”), Multiple Input Multiple Output (“MIMO”), Maximum Permissible Exposure (“MPE”), Most-Significant Bit (“MSB”), Mobile-Termination (“MT”), Machine Type Communication (“MTC”), Multi PDSCH (“Multi-PDSCH”), Multi TRP (“M-TRP”), Multi-User (“MU”), Multi-User MIMO (“MU-MIMO”), Minimum Mean Square Error (“MMSE”), Negative-Acknowledgment (“NACK”) or (“NAK”), Non-Coherent Joint Transmission (“NCJT”), Next Generation (“NG”), Next Generation Node B (“gNB”), New Radio (“NR”), Non-Zero Power (“NZP”), NZP CSI-RS (“NZP-CSI-RS”), Orthogonal Frequency Division Multiplexing (“OFDM”), Peak-to-Average Power Ratio (“PAPR”), Physical Broadcast Channel (“PBCH”), Physical Downlink Control Channel (“PDCCH”), Physical Downlink Shared Channel (“PDSCH”), PDSCH Configuration (“PDSCH-Config”), Policy Control Function (“PCF”), Packet Data Convergence Protocol (“PDCP”), Packet Data Network (“PDN”), Protocol Data Unit (“PDU”), Public Land Mobile Network (“PLMN”), Precoding Matrix Indicator (“PMI”), ProSe Per Packet Priority (“PPPP”), ProSe Per Packet Reliability (“PPPR”), Physical Resource Block (“PRB”), Packet Switched (“PS”), Physical Sidelink Control Channel (“PSCCH”), Physical Sidelink Shared Channel (“PSSCH”), Phase Tracking RS (“PTRS” or “PT-RS”), Physical Uplink Control Channel (“PUCCH”), Physical Uplink Shared Channel (“PUSCH”), Quasi Co-Located (“QCL”), Quality of Service (“QoS”), Random Access Channel (“RACH”), Radio Access Network (“RAN”), Radio Access Technology (“RAT”), Resource Element (“RE”), Radio Frequency (“RF”), Rank Indicator (“RI”), Radio Link Control (“RLC”), Radio Link Failure (“RLF”), Radio Network Temporary Identifier (“RNTI”), Resource Pool (“RP”), Radio Resource Control (“RRC”), Remote Radio Head (“RRH”), Reference Signal (“RS”), Reference Signal Received Power (“RSRP”), Reference Signal Received Quality (“RSRQ”), Redundancy Version (“RV”), Receive (“RX”), Single Carrier Frequency Domain Spread Spectrum (“SC-FDSS”), Secondary Cell (“SCell”), Spatial Channel Model (“SCM”), Sub Carrier Spacing (“SCS”), Single DCI (“S-DCI”), Spatial Division Multiplexing (“SDM”), Service Data Unit (“SDU”), Single Frequency Network (“SFN”), Subscriber Identity Module (“SIM”), Signal-to-Interference Ratio (“SINR”), Sidelink (“SL”), Sequence Number (“SN”), Semi Persistent (“SP”), Scheduling Request (“SR”), SRS Resource Indicator (“SRI”), Sounding Reference Signal (“SRS”), Synchronization Signal (“SS”), SS/PBCH Block (“SSB”), Transport Block (“TB”), Transmission Configuration Indication (“TCI”), Time Division Duplex (“TDD”), Time Division Multiplexing (“TDM”), Temporary Mobile Subscriber Identity (“TMSI”), Transmit Power Control (“TPC”), Transmitted Precoding Matrix Indicator (“TPMI”), Transmission Reception Point (“TRP”), Transmission Reference Signal (“TRS”), Technical Standard (“TS”), Transmit (“TX”), User Entity/Equipment (Mobile Terminal) (“UE”), Universal Integrated Circuit Card (“UICC”), Uplink (“UL”), Unacknowledged Mode (“UM”), Universal Mobile Telecommunications System (“UMTS”), LTE Radio Interface (“Uu interface”), User Plane (“UP”), Ultra Reliable Low Latency Communication (“URLLC”), Universal Subscriber Identity Module (“USIM”), Universal Terrestrial Radio Access Network (“UTRAN”), Vehicle to Everything (“V2X”), Voice Over IP (“VoIP”), Visited Public Land Mobile Network (“VPLMN”), Virtual Resource Block (“VRB”), Vehicle RNTI (“V-RNTI”), Worldwide Interoperability for Microwave Access (“WiMAX”), Zero Forcing (“ZF”), Zero Power (“ZP”), and ZP CSI-RS (“ZP-CSI-RS”). As used herein, “HARQ-ACK” may represent collectively the Positive Acknowledge (“ACK”) and the Negative Acknowledge (“NAK”). ACK means that a TB is correctly received while NAK means a TB is erroneously received.

In certain wireless communications networks, Doppler shift may occur.

### BRIEF SUMMARY

Methods for Doppler shift frequency determination and compensation are disclosed. Apparatuses and systems also perform the functions of the methods. In one embodiment, the method includes transmitting, from a first transmission reception point, a first reference signal to a user equipment on a first frequency. In certain embodiments, the method includes receiving, at the first transmission reception point, a second reference signal from the user equipment on a second frequency, wherein the second frequency is based on a third frequency on which the user equipment received the first reference signal. In some embodiments, the method includes determining a first Doppler shift frequency using the first frequency and the second frequency. In various embodiments, future transmissions are made from the first transmission reception point using a frequency that is adjusted based on the determined first Doppler shift frequency.

An apparatus for Doppler shift frequency determination and compensation, in one embodiment, includes a transmitter that transmits, from a first transmission reception point, a first reference signal to a user equipment on a first frequency. In various embodiments, the apparatus includes a receiver that receives, at the first transmission reception point, a second reference signal from the user equipment on a second frequency, wherein the second frequency is based on a third frequency on which the user equipment received the first reference signal. In certain embodiments, the apparatus includes a processor that determines a first Doppler shift frequency using the first frequency and the second frequency. In various embodiments, future transmissions are made from the first transmission reception point using a frequency that is adjusted based on the determined first Doppler shift frequency.

A method for Doppler shift frequency determination and compensation includes receiving, at a user equipment, a first reference signal transmitted from a first transmission reception point on a third frequency. In some embodiments, the method includes transmitting, from the user equipment, a second reference signal to the first transmission reception point on the third frequency, wherein the third frequency is based on a first frequency on which the first transmission reception point transmitted the first reference signal; wherein a first Doppler shift frequency is determined by the first transmission reception point using the first frequency and a second frequency on which the second reference signal is received by the first transmission reception point. In various embodiments, future receptions are received from the first transmission reception point using a frequency that is adjusted based on the determined first Doppler shift frequency.

An apparatus for Doppler shift frequency determination and compensation, in one embodiment, includes a user equipment. In certain embodiments, the apparatus includes a receiver that receives, at the user equipment, a first reference signal transmitted from a first transmission reception point on a third frequency. In various embodiments, the apparatus includes a transmitter that transmits, from the user equipment, a second reference signal to the first transmission reception point on the third frequency, wherein the third frequency is based on a first frequency on which the first transmission reception point transmitted the first reference signal; wherein a first Doppler shift frequency is determined by the first transmission reception point using the first frequency and a second frequency on which the second reference signal is received by the first transmission reception point. In various embodiments, future receptions are received from the first transmission reception point using a frequency that is adjusted based on the determined first Doppler shift frequency.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for Doppler shift frequency determination and compensation;

FIG. 2 is a schematic block diagram illustrating one embodiment of an apparatus that may be used for Doppler shift frequency determination and compensation;

FIG. 3 is a schematic block diagram illustrating one embodiment of an apparatus that may be used for Doppler shift frequency determination and compensation;

FIG. 4 is a schematic block diagram illustrating one embodiment of a system in which there is a Doppler shift between two TRPs and a UE;

FIG. 5 is a schematic block diagram illustrating one embodiment of communications including joint transmission from two TRPs to a UE, wherein the frequency offset between a TRS and a CSI-RS is sent from a TRP to a UE only if QCL-TypeF is configured;

FIG. 6 is a schematic flow chart diagram illustrating one embodiment of a method for Doppler shift frequency determination and compensation; and

FIG. 7 is a schematic flow chart diagram illustrating another embodiment of a method for Doppler shift frequency determination and compensation.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

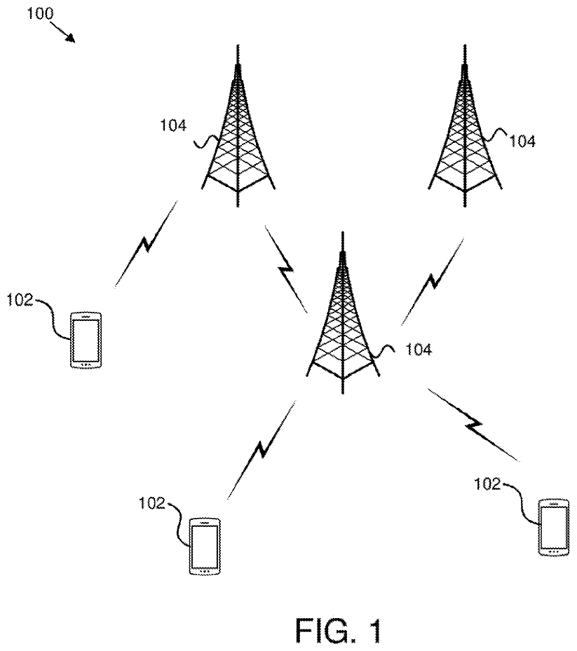

FIG. 1 depicts an embodiment of a wireless communication system 100 for Doppler shift frequency determination and compensation. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), IoT devices, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals and/or the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a RAN, a relay node, a device, a network device, an IAB node, a donor IAB node, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with the 5G or NG (Next Generation) standard of the 3GPP protocol, wherein the network unit 104 transmits using NG RAN technology. More generally, however, the wireless communication system 100 may implement some other open or proprietary communication protocol, for example, WiMAX, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may transmit, from a first transmission reception point, a first reference signal to a user equipment (e.g., remote unit 102) on a first frequency. In certain embodiments, the network unit 104 may receive, at the first transmission reception point, a second reference signal from the user equipment on a second frequency, wherein the second frequency is based on a third frequency on which the user equipment received the first reference signal. In some embodiments, the network unit 104 may determine a first Doppler shift frequency using the first frequency and the second frequency. Accordingly, a network unit 104 may be used for Doppler shift frequency determination and compensation.

In some embodiments, a remote unit 102 (e.g., user equipment) may receive a first reference signal transmitted from a first transmission reception point on a third frequency. In some embodiments, the remote unit 102 may transmit a second reference signal to the first transmission reception point on the third frequency, wherein the third frequency is based on a first frequency on which the first transmission reception point transmitted the first reference signal; wherein a first Doppler shift frequency is determined by the first transmission reception point using the first frequency and a second frequency on which the second reference signal is received by the first transmission reception point. Accordingly, a remote unit 102 may be used for Doppler shift frequency determination and compensation.

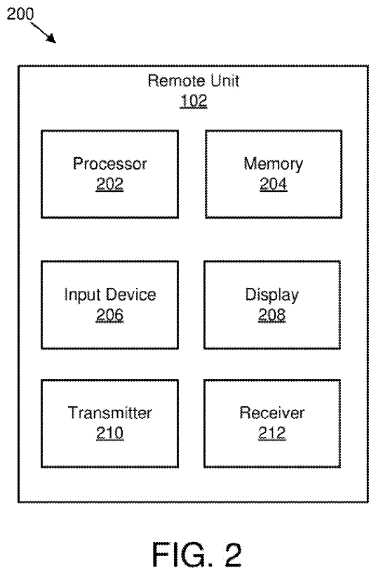

FIG. 2 depicts one embodiment of an apparatus 200 that may be used for Doppler shift frequency determination and compensation. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, an LCD display, an LED display, an OLED display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In some embodiments, the receiver 212 may receive a first reference signal transmitted from a first transmission reception point on a third frequency. In various embodiments, the transmitter 210 may transmit a second reference signal to the first transmission reception point on the third frequency, wherein the third frequency is based on a first frequency on which the first transmission reception point transmitted the first reference signal; wherein a first Doppler shift frequency is determined by the first transmission reception point using the first frequency and a second frequency on which the second reference signal is received by the first transmission reception point.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

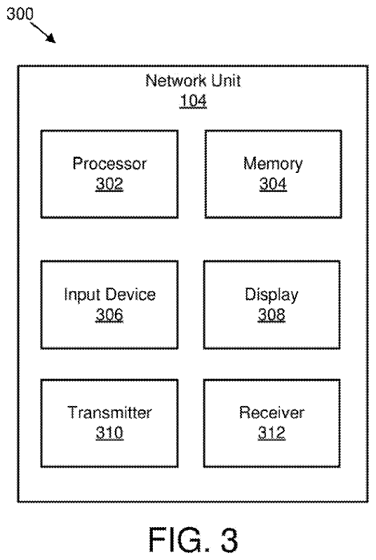

FIG. 3 depicts one embodiment of an apparatus 300 that may be used for Doppler shift frequency determination and compensation. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In various embodiments, the transmitter 310 may transmit, from a first transmission reception point, a first reference signal to a user equipment on a first frequency. In various embodiments, the receiver 312 may receive, at the first transmission reception point, a second reference signal from the user equipment on a second frequency, wherein the second frequency is based on a third frequency on which the user equipment received the first reference signal. In certain embodiments, the processor 302 may determine a first Doppler shift frequency using the first frequency and the second frequency.

Although only one transmitter 310 and one receiver 312 are illustrated, the network unit 104 may have any suitable number of transmitters 310 and receivers 312. The transmitter 310 and the receiver 312 may be any suitable type of transmitters and receivers. In one embodiment, the transmitter 310 and the receiver 312 may be part of a transceiver.

In various embodiments, a network may transmit to a UE with Doppler shift a frequency offset so that a signal received by the UE does not exhibit Doppler shift (e.g., for ease of reception).

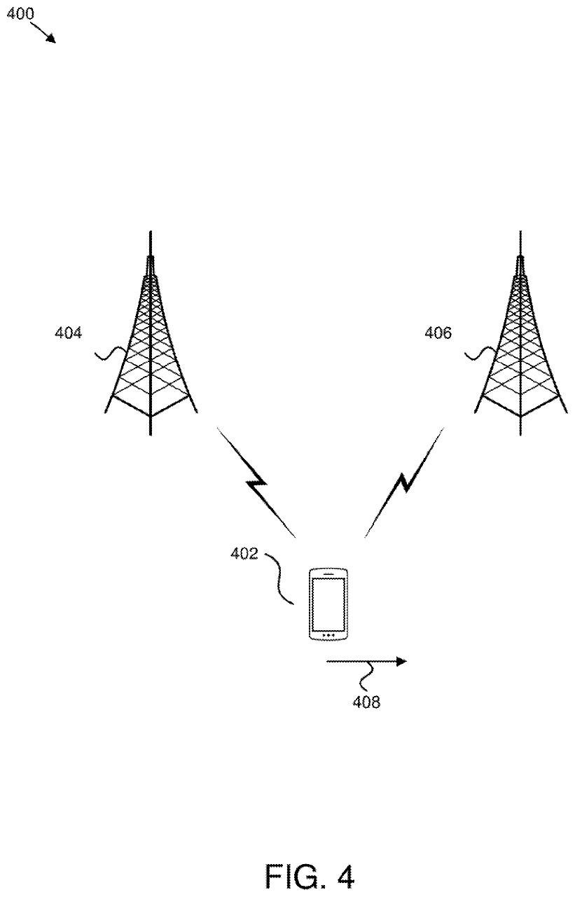

FIG. 4 is a schematic block diagram illustrating one embodiment of a system 400 in which there is a Doppler shift between two TRPs and a UE. The system 400 includes a UE 402, a first TRP 404 (TRP1), and a second TRP 406 (TRP2). In various embodiments, the UE 402 travels in a direction 408 at a velocity v. In certain embodiments, a first Doppler shift ΔF1 may occur in transmissions (k1) between the UE 402 and the first TRP 404, and a second Doppler shift ΔF2 may occur in transmissions (k2) between the UE 402 and the second TRP 406.

As may be appreciated, Doppler shift may be due to relative movement between a TRP (e.g., TRP1, TRP2) and a UE (e.g., UE 402). For the UE 402 moving at velocity r, the Doppler shift between the UE 402 and TRP1 and/or TRP2 is given by the following:

$$Δ F 1 = \frac{\vec{k 1} \cdot \vec{v}}{c} {F}_{c} ,$$

$$Δ F 2 = \frac{\vec{k 2} \cdot \vec{v}}{c} {F}_{c}$$

Where c is the speed of light, F_{c} is the carrier frequency, and \vec{k1} \vec{(k2)} is the (unit length) direction vector pointing from the UE 402 to TRP1 (TRP2). In general |\vec{k1}|≠|\vec{k2}|, so |ΔF1| #|ΔF2|.

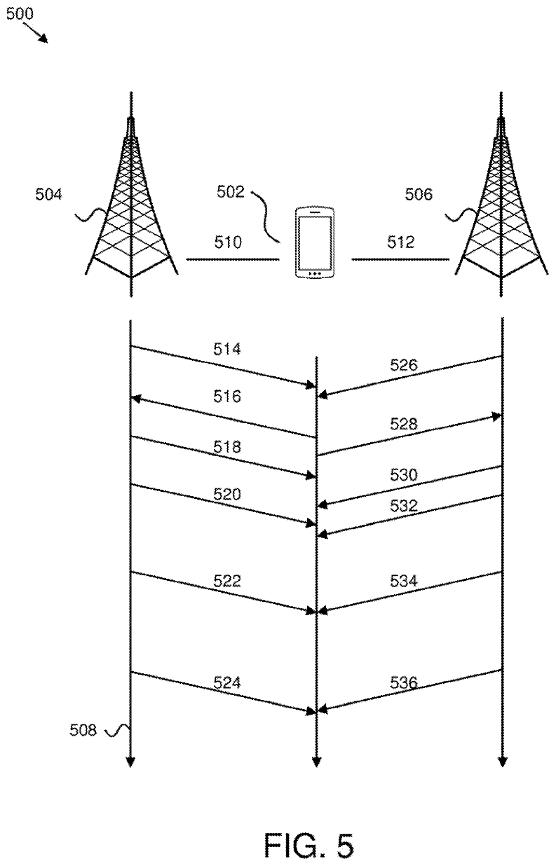

FIG. 5 is a schematic block diagram illustrating one embodiment of communications 500 including joint transmission from two TRPs to a UE, wherein the frequency offset between a TRS and a CSI-RS is sent from a TRP to a UE (e.g., only if QCL-TypeF is configured). The communications 500 include messages sent between a UE 502, a first TRP 504 (TRP1), and a second TRP 506 (TRP2) over a time 508. A first Doppler shift 510 (ΔF1) occurs between the first TRP 504 and the UE 502, and a second Doppler shift 512 (ΔF2) occurs between the second TRP 506 and the UE 502.

The first TRP 504 transmits TRS1 514 via a frequency F_{c} that is received by the UE 502 at a frequency F_{c}+ΔF1. The UE 502 transmits SRS1 516 via a frequency F_{c}+ΔF1 that is received by the first TRP 504 at a frequency F_{c}+2*ΔF1. The TRP 504 obtains an estimate of the Doppler shift ΔF1 by comparing the transmitted frequency of 514 and the received frequency of 516. In some embodiments, the first TRP 504 transmits a determined frequency offset 518 between TRS1 514 and CSI-RS1 520 (e.g., QCL-TypeF only).

The first TRP 504 transmits CSI-RS1 520 at a frequency F_{c}+ΔF1 that is received by the UE 502 at a frequency F_{c}. Moreover, the first TRP 504 transmits PDCCH DMRS 522 at a frequency F_{c}+ΔF1 that is received by the UE 502 at a frequency F_{c}. Further, the first TRP 504 transmits PDSCH DMRS 524 at a frequency F_{c}+ΔF1 that is received by the UE 502 at a frequency F_{c}.

The second TRP 506 transmits TRS2 526 via a frequency Fe that is received by the UE 502 at a frequency F_{c}+ΔF2. The UE 502 transmits SRS2 528 via a frequency F_{c}+ΔF2 that is received by the second TRP 506 at a frequency F_{c}+2*ΔF2. The TRP 506 obtains an estimate of the Doppler shift ΔF2 by comparing the transmitted frequency of 526 and the received frequency of 528. In some embodiments, the second TRP 506 transmits a determined frequency offset 530 between TRS2 526 and CSI-RS2 532 (e.g., QCL-TypeF only).

The second TRP 506 transmits CSI-RS2 532 at a frequency F_{c}+ΔF2 that is received by the UE 502 at a frequency F_{c}. Moreover, the second TRP 506 transmits PDCCH DMRS 534 at a frequency F_{c}+ΔF2 that is received by the UE 502 at a frequency F_{c}. Further, the second TRP 506 transmits PDSCH DMRS 536 at a frequency F_{c}+ΔF2 that is received by the UE 502 at a frequency F_{c}.

Moreover, FIG. 5 shows the operation of embodiments found herein. Each signal sent between a TRP (e.g., first TRP 504 and second TRP 506) and the UE 502 is represented with a directed line, where the arrow shows the direction of the transmission. Due to the UE 502 movement, the effective Doppler shift at the carrier Fe is ΔF1 between TRP1 and the UE 502, and ΔF2 between TRP2 and the UE 502. Depending on the direction of the UE 502 movement, ΔF1 and ΔF2 may take on different signs, but there is no guarantee that they have the same amplitude (e.g., see FIG. 4). This may be especially true if the TRPs are deployed some distance away from a road the UE 502 travels. For this reason, frequency estimation and pre-compensation may be performed on a per-TRP basis. Due to Doppler shift and a set forth above, the frequency of a signal transmitted is not the same as the frequency it is received.

In certain embodiments of a PDSCH joint transmission scheme, two TRPs of a same cell transmit their TRS (TRS1 514 by TRP1, TRS2 526 by TRP2) in separate CSI-RS resources. TRP1 transmits its TRS1 514 with fixed frequency F_{c}, but because of Doppler effect, it is received at the UE 502 at frequency F_{c}+ΔF1. In some embodiments, the UE 502 does not have an absolute frequency reference itself and relies on received DL signal CSI-RS1 520 for frequency synchronization with TRP1. Because of this, the UE 502 cannot tell the Doppler shift ΔF1 from the received signal. The UE 502 is configured with a SRS resource (SRS1 516) which is configured to be transmitted using TRS1 514 as a reference both in frequency and in TX filter. In various embodiments, if the TX beam of the SRS1 516 is represented by its spatialRelation, TRS1 514 is configured as its spatialRelation. If UL-TCI is used to indicate the TX beam (TX spatial filter), TRS1 514 is configured as its UL-TCI state. In either case, the UE 502 transmits SRS1 516 using the same spatial filter (and same panel if it is equipped with more than 1 antenna panel) it uses to receive TRS1 514. By TX/RX beam correspondence, SRS1 516 is sent to TRP1 through the same DL beam of TRS1 514. The UE 502 transmits SRS1 516 using the received frequency (F_{c}+ΔF1) as reference 1. For FDD or carrier aggregation, a normal frequency offset between UL and/or DL or different CCs may also be applied even though TDD is used as an example. Because of Doppler effect, TRP1 receives SRS1 516 at frequency F_{c}+2*ΔF1. By comparing the transmission frequency of TRS1 514 and received frequency of SRS1 516, a gNB (e.g., TRP1) is able to derive Doppler shift as (F_{c}+2*ΔF1-F_{c})/2=ΔF1. In certain embodiments, the gNB may transmit to the UE 502 a CSI-RS resource (CSI-RS1 520) with frequency offset of −ΔF1. The TX frequency of CSI-RS1 520 is F_{c}-ΔF1 and its received frequency at the UE 502 is F_{c}. TRS1 514 and CSI-RS1 520 are transmitted with the same TX spatial filter (e.g., same TX beam) but CSI-RS1 520 is transmitted with a frequency offset −ΔF1. Similarly, TRS2 526, SRS2 528, and CSI-RS2 532 are transmitted between TRP2 and the UE 502, and the transmission and receiving frequencies of these signals are illustrated in relation to FIG. 5. CSI-RS1 520 and CSI-RS2 532 are used as reference to further transmissions to the UE 502, including CSI measurement and feedback by the UE 502.

In some embodiments, TRS1 514 and CSI-RS1 520 are both transmitted from TRP1, so they share the same average delay, delay spread, and/or spatial property. In such embodiments, a new type of QCL may be defined as:

‘QCL-TypeE’: {Average delay, delay spread}

In various embodiments, CSI-RS1 520 may be signaled as QCL-TypeE and/or QCL-TypeD if applicable with respect to TRS1 514 to assist the UE 502 to better receive CSI-RS1 520.

In certain embodiments, in the frequency domain, there may be a frequency shift of −ΔF1 between TRS1 514 and CSI-RS1 520. This frequency shift may be considered as a difference in Doppler shift (e.g., −ΔF1). In such embodiments, the Doppler spread of CSI-RS1 520 may be:

$${DopplerSpreader}_{CSI - RS 1} = \frac{- Δ F 1}{{F}_{c}} {DopplerSpread}_{TRS 1}$$

In some embodiments, if the UE 502 has frequency offset information (−ΔF1), the UE 502 may derive Doppler shift and/or Doppler spread at a new frequency (e.g., F_{c}-ΔF1). The Doppler shift and/or Doppler spread may be derived from TRS1 514 even though TRS1 514 is transmitted at F_{c}. In various embodiments, the frequency difference may be signaled by TRP1 to the UE 502 to assist the UE 502 to better receive CSI-RS1 520. This enables another way to define a QCL type between TRS1 514 and CSI-RS1 520. In addition to average delay and delay spread, this QCL relation may also include Doppler shift and Doppler spread considering the change of transmission frequency.

In certain embodiments, there may be ‘QCL-TypeF’: {Doppler shift with frequency offset, Doppler spread with frequency offset, Average delay, delay spread}.

In various embodiments, a signaling mechanism may be used for a gNB to signal a frequency offset between two QCLed signals.

In some embodiments, PDCCH may be transmitted following CSI-RST 520 and CSI-RS2 532 in a SFN manner. In various embodiments, PDCCH and/or PDSCH may be transmitted from TRP1 alone and/or from TRP2 alone. In certain embodiments, a TI state may be configured in RRC to correspond to both CSI-RST 520 and CSI-RS2 532 as QCL-TypeA and/or QCL-TypeD, if applicable. In such embodiments, DMRS of PDCCH may be transmitted using the TCI state after a TCI state indication from MAC-CE, and may be used for single layer PDCCH transmission.

In various embodiments, SFN PDSCH transmission may be based on CSI-RS1 520 and CSI-RS2 532. After TCI activation via MAC-CE with both CSI-RSJ 520 and CSI-RS2 532 as QCL-TypeA, and QCL-TypeD if applicable, PDSCH may be transmitted with a corresponding TCI state. In some embodiments, two different approaches may be taken with respect to PDSCH DMRS. In a first embodiment, DMRS may be transmitted in separate ports from two TRPs, where the first N ports sent from the TRP1 are QCLed with respect to CSI-RST 520, and the next N ports sent from the TRP2 are QCLed with respect to CSI-RS2 532. In the second embodiment, a pair of DMRS ports from the two TRPs forms the basis of each transmitted data layer. In a second embodiment, each DMRS port is transmitted from both TRPs as a SFN which is QCLed with respect to both CSI-RS1 520 and CSI-RS2 532.

In certain embodiments, such as in a tunnel in which TRPs are deployed very close to a road or railway track, the UE 502 may be considered traveling from TRP1 to TRP2. In such embodiments, there may be approximately \vec{k2}=−\vec{k1} and ΔF2=−ΔF1. In such embodiments, TRP1 may send to TRP2 its frequency estimation ΔF1. This may eliminate the need for TRS2 526 and SRS2 528 and may enable TRP2 to transmit CSI-RS2 532 with proper frequency compensation (−ΔF2=ΔF1).

In some embodiments, for CSI measurement, CSI-RS1 520 and CSI-RS2 532 may be configured for channel measurement. In such embodiments, the UE 502 may need to be configured with a SFN PDSCH transmission mode so the UE 502 any compute the CSI, including RI and CQI under the SFN transmission assumption.

In various embodiments, TRS1 514 is transmitted with fixed carrier frequency; TRS1 514 is RRC configured as a TX beam for SRS1 516 (spatialRelation or UL-TCI); the UE 502 transmits SRS1 516 using received TRS1 514 frequency as reference (e.g., no Doppler shift estimation) and a gNB estimates Doppler shift from the received SRS1 516 and uses its estimation for frequency pre-compensation; a QCL relation between TRS1 514 and CSI-RS1 520 of a QCL-TypeD, a QCL-TypeE (e.g., average delay, delay spread), and/or a QCL-TypeF (e.g., Doppler shift with frequency offset, Doppler spread with frequency offset, average delay, delay spread); TRP1 send to the UE 502 information of the frequency offset it applies between CSI-RS1 520 and TRS1 514; TRP1 may send to TRP2 its estimation of the Doppler shift frequency (ΔF1)—in which TRP2 derives its Doppler shift frequency (−ΔF2=ΔF1) without using TRS2 526 and SRS2 528 signals; CSI-RS1 520 and CSI-RS2 532 as TCI for PDCCH in which a SFN PDCCH is transmitted from TRP1 and TRP2 to the UE 502 and two TCI states for 1 DMRS port are used for the PDCCH transmission; CSI-RS1 520 and CSI-RS2 532 as TCI for PDSCH in which a SFN PDSCH DMRS is transmitted from TRP1 and TRP2 to the UE 502 and there are two TCI states for DMRS and N SFN DMRS ports are used for N layer PDSCH transmission; and CSI measurement and feedback are based on CSI-RS1 520 and CSI-RS2 532.

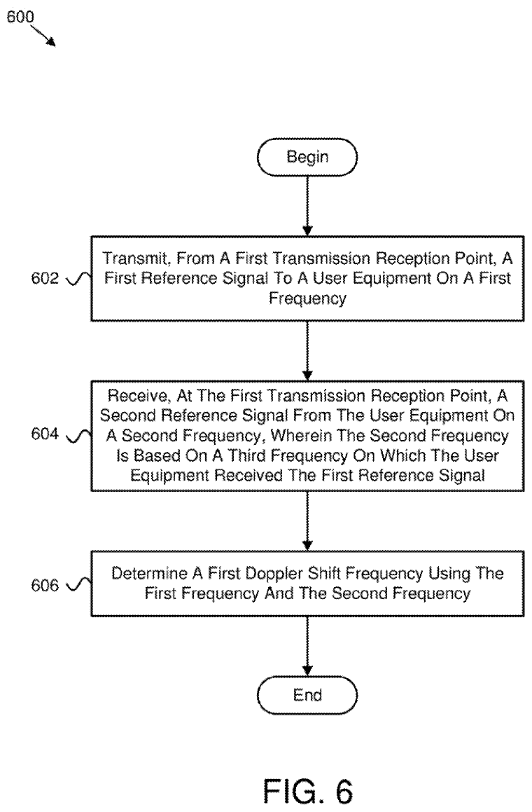

FIG. 6 is a schematic flow chart diagram illustrating one embodiment of a method 600 for Doppler shift frequency determination and compensation. In some embodiments, the method 600 is performed by an apparatus, such as the network unit 104. In certain embodiments, the method 600 may be performed by a processor executing program code, for example, a microcontroller, a microprocessor, a CPU, a GPU, an auxiliary processing unit, a FPGA, or the like.

The method 600 may include transmitting 602, from a first transmission reception point, a first reference signal to a user equipment (e.g., remote unit 102) on a first frequency. In certain embodiments, the method 600 includes receiving 604, at the first transmission reception point, a second reference signal from the user equipment on a second frequency, wherein the second frequency is based on a third frequency on which the user equipment received the first reference signal. In some embodiments, the method 600 includes determining 606 a first Doppler shift frequency using the first frequency and the second frequency.

In certain embodiments, the first Doppler shift frequency is determined based on a difference between the first frequency and the second frequency. In some embodiments, the second reference signal is configured by the first transmission reception point with the same spatial relation and frequency reference as the first reference signal. In various embodiments, the method 600 further comprises transmitting, from the first transmission reception point, a third reference signal having a fourth frequency determined based on the first Doppler shift frequency.

In one embodiment, the third reference signal is configured by radio resource control signaling as a first quasi-co-location type with respect to the first reference signal. In certain embodiments, the third reference signal is configured by radio resource control signaling as a quasi-co-location type D with respect to the first reference signal. In some embodiments, the first quasi-colocation type comprises an average delay, a delay spread, a Doppler shift with frequency offset, a Doppler spread with frequency offset, or some combination thereof.

In various embodiments, the method 600 further comprises transmitting, from the first transmission reception point, a frequency difference between the first frequency and the third frequency. In one embodiment, the method 600 further comprises: transmitting, from a second transmission reception point, a fourth reference signal to the user equipment on a fifth frequency; receiving, at the second transmission reception point, a fifth reference signal from the user equipment on a sixth frequency, wherein the sixth frequency is based on a seventh frequency on which the user equipment received the fourth reference signal; and determining a second Doppler shift frequency using the fifth frequency and the sixth frequency.

In certain embodiments, the method 600 further comprises providing the first Doppler shift frequency from the first transmission reception point to a second transmission reception point. In some embodiments, the method 600 further comprises transmitting, from the second transmission reception point, a sixth reference signal having an eighth frequency determined based on the second Doppler shift frequency.

In various embodiments, the fourth reference signal and the sixth reference signal are configured as transmission configuration indicators for a control channel transmission to the user equipment. In one embodiment, the fourth reference signal and the sixth reference signal are configured for channel state information measurement and feedback by the user equipment. In certain embodiments, the fourth reference signal and the sixth reference signal are configured as transmission configuration indicators for a shared channel transmission to the user equipment.

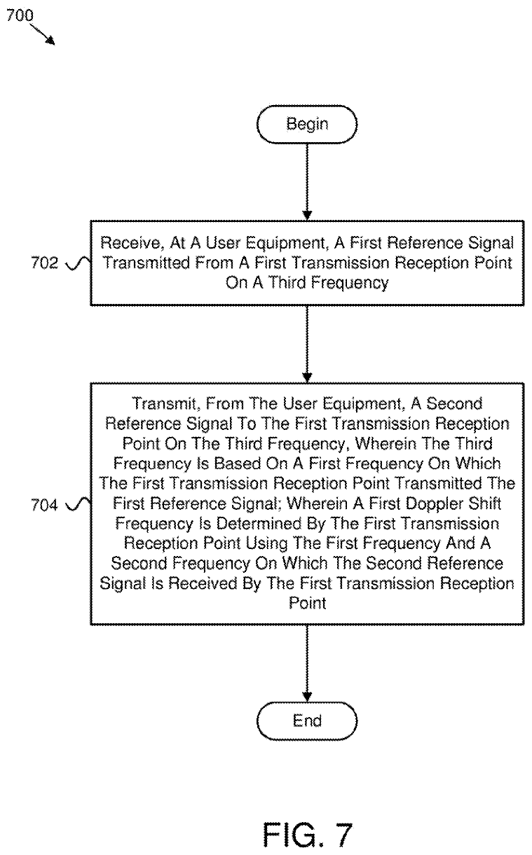

FIG. 7 is a schematic flow chart diagram illustrating another embodiment of a method 700 for Doppler shift frequency determination and compensation. In some embodiments, the method 700 is performed by an apparatus, such as the remote unit 102. In certain embodiments, the method 700 may be performed by a processor executing program code, for example, a microcontroller, a microprocessor, a CPU, a GPU, an auxiliary processing unit, a FPGA, or the like.

The method 700 may include receiving 702 a first reference signal transmitted from a first transmission reception point on a third frequency. In some embodiments, the method 700 includes transmitting 704 a second reference signal to the first transmission reception point on the third frequency, wherein the third frequency is based on a first frequency on which the first transmission reception point transmitted the first reference signal; wherein a first Doppler shift frequency is determined by the first transmission reception point using the first frequency and a second frequency on which the second reference signal is received by the first transmission reception point.

In certain embodiments, the first Doppler shift frequency is determined based on a difference between the first frequency and the second frequency. In some embodiments, the second reference signal is configured by the first transmission reception point with the same spatial relation and frequency reference as the first reference signal. In various embodiments, the method 700 further comprises receiving, from the first transmission reception point, a third reference signal having a fourth frequency determined based on the first Doppler shift frequency.

In one embodiment, the third reference signal is configured by radio resource control signaling as a first quasi-co-location type with respect to the first reference signal. In certain embodiments, the third reference signal is configured by radio resource control signaling as a quasi-co-location type D with respect to the first reference signal. In some embodiments, the first quasi-colocation type comprises an average delay, a delay spread, a Doppler shift with frequency offset, a Doppler spread with frequency offset, or some combination thereof.

In various embodiments, the method 700 further comprises receiving, from the first transmission reception point, a frequency difference between the first frequency and the third frequency. In one embodiment, the method 700 further comprises: receiving, at the user equipment, a fourth reference signal transmitted from a second transmission reception point on a seventh frequency; and transmitting, from the user equipment, a fifth reference signal to the second transmission reception point on the seventh frequency, wherein the seventh frequency is based on a fifth frequency on which the user equipment transmitted the fourth reference signal; wherein a second Doppler shift frequency is determined by the second transmission reception point using the fifth frequency and a sixth frequency on which the fifth reference signal is received by the second transmission reception point.

In certain embodiments, the method 700 further comprises receiving, from the second transmission reception point, a sixth reference signal having an eighth frequency determined based on the second Doppler shift frequency. In some embodiments, the fourth reference signal and the sixth reference signal are configured as transmission configuration indicators for a control channel transmission to the user equipment. In various embodiments, the method 700 further comprises using the transmission configuration indicators to decode a control channel reference signal and control channel data.

In one embodiment, the method 700 further comprises using the fourth reference signal and the sixth reference signal for channel state information computation and for providing channel state information feedback. In certain embodiments, the fourth reference signal and the sixth reference signal are configured for channel state information measurement and feedback by the user equipment.

In some embodiments, the fourth reference signal and the sixth reference signal are configured as transmission configuration indicators for a shared channel transmission to the user equipment. In various embodiments, the method 700 further comprises using the transmission configuration indicators to decode a shared channel reference signal and shared channel data.

In one embodiment, a method comprises: transmitting, from a first transmission reception point, a first reference signal to a user equipment on a first frequency; receiving, at the first transmission reception point, a second reference signal from the user equipment on a second frequency, wherein the second frequency is based on a third frequency on which the user equipment received the first reference signal; and determining a first Doppler shift frequency using the first frequency and the second frequency.

In certain embodiments, the first Doppler shift frequency is determined based on a difference between the first frequency and the second frequency.

In some embodiments, the second reference signal is configured by the first transmission reception point with the same spatial relation and frequency reference as the first reference signal.

In various embodiments, the method further comprises transmitting, from the first transmission reception point, a third reference signal having a fourth frequency determined based on the first Doppler shift frequency.

In one embodiment, the third reference signal is configured by radio resource control signaling as a first quasi-co-location type with respect to the first reference signal.

In certain embodiments, the third reference signal is configured by radio resource control signaling as a quasi-co-location type D with respect to the first reference signal.

In some embodiments, the first quasi-colocation type comprises an average delay, a delay spread, a Doppler shift with frequency offset, a Doppler spread with frequency offset, or some combination thereof.

In various embodiments, the method further comprises transmitting, from the first transmission reception point, a frequency difference between the first frequency and the third frequency.

In one embodiment, the method further comprises: transmitting, from a second transmission reception point, a fourth reference signal to the user equipment on a fifth frequency; receiving, at the second transmission reception point, a fifth reference signal from the user equipment on a sixth frequency, wherein the sixth frequency is based on a seventh frequency on which the user equipment received the fourth reference signal; and determining a second Doppler shift frequency using the fifth frequency and the sixth frequency.

In certain embodiments, the method further comprises providing the first Doppler shift frequency from the first transmission reception point to a second transmission reception point.

In some embodiments, the method further comprises transmitting, from the second transmission reception point, a sixth reference signal having an eighth frequency determined based on the second Doppler shift frequency.

In various embodiments, the fourth reference signal and the sixth reference signal are configured as transmission configuration indicators for a control channel transmission to the user equipment.

In one embodiment, the fourth reference signal and the sixth reference signal are configured for channel state information measurement and feedback by the user equipment.

In certain embodiments, the fourth reference signal and the sixth reference signal are configured as transmission configuration indicators for a shared channel transmission to the user equipment.

In one embodiment, an apparatus comprises: a transmitter that transmits, from a first transmission reception point, a first reference signal to a user equipment on a first frequency; a receiver that receives, at the first transmission reception point, a second reference signal from the user equipment on a second frequency, wherein the second frequency is based on a third frequency on which the user equipment received the first reference signal; and a processor that determines a first Doppler shift frequency using the first frequency and the second frequency.

In certain embodiments, the first Doppler shift frequency is determined based on a difference between the first frequency and the second frequency.

In some embodiments, the second reference signal is configured by the first transmission reception point with the same spatial relation and frequency reference as the first reference signal.

In various embodiments, the transmitter transmits, from the first transmission reception point, a third reference signal having a fourth frequency determined based on the first Doppler shift frequency.

In one embodiment, the third reference signal is configured by radio resource control signaling as a first quasi-co-location type with respect to the first reference signal.

In certain embodiments, the third reference signal is configured by radio resource control signaling as a quasi-co-location type D with respect to the first reference signal.

In some embodiments, the first quasi-colocation type comprises an average delay, a delay spread, a Doppler shift with frequency offset, a Doppler spread with frequency offset, or some combination thereof.

In various embodiments, the transmitter transmits, from the first transmission reception point, a frequency difference between the first frequency and the third frequency.

In one embodiment: the transmitter transmits, from a second transmission reception point, a fourth reference signal to the user equipment on a fifth frequency; the receiver receives, at the second transmission reception point, a fifth reference signal from the user equipment on a sixth frequency, wherein the sixth frequency is based on a seventh frequency on which the user equipment received the fourth reference signal; and the processor determines a second Doppler shift frequency using the fifth frequency and the sixth frequency.

In certain embodiments, the processor provides the first Doppler shift frequency from the first transmission reception point to a second transmission reception point.

In some embodiments, the transmitter transmits, from the second transmission reception point, a sixth reference signal having an eighth frequency determined based on the second Doppler shift frequency.

In various embodiments, the fourth reference signal and the sixth reference signal are configured as transmission configuration indicators for a control channel transmission to the user equipment.

In one embodiment, the fourth reference signal and the sixth reference signal are configured for channel state information measurement and feedback by the user equipment.

In certain embodiments, the fourth reference signal and the sixth reference signal are configured as transmission configuration indicators for a shared channel transmission to the user equipment.

In one embodiment, a method comprises: receiving, at a user equipment, a first reference signal transmitted from a first transmission reception point on a third frequency; and transmitting, from the user equipment, a second reference signal to the first transmission reception point on the third frequency, wherein the third frequency is based on a first frequency on which the first transmission reception point transmitted the first reference signal; wherein a first Doppler shift frequency is determined by the first transmission reception point using the first frequency and a second frequency on which the second reference signal is received by the first transmission reception point.

In certain embodiments, the first Doppler shift frequency is determined based on a difference between the first frequency and the second frequency.

In some embodiments, the second reference signal is configured by the first transmission reception point with the same spatial relation and frequency reference as the first reference signal.

In various embodiments, the method further comprises receiving, from the first transmission reception point, a third reference signal having a fourth frequency determined based on the first Doppler shift frequency.

In one embodiment, the third reference signal is configured by radio resource control signaling as a first quasi-co-location type with respect to the first reference signal.

In certain embodiments, the third reference signal is configured by radio resource control signaling as a quasi-co-location type D with respect to the first reference signal.

In some embodiments, the first quasi-colocation type comprises an average delay, a delay spread, a Doppler shift with frequency offset, a Doppler spread with frequency offset, or some combination thereof.

In various embodiments, the method further comprises receiving, from the first transmission reception point, a frequency difference between the first frequency and the third frequency.

In one embodiment, the method further comprises: receiving, at the user equipment, a fourth reference signal transmitted from a second transmission reception point on a seventh frequency; and transmitting, from the user equipment, a fifth reference signal to the second transmission reception point on the seventh frequency, wherein the seventh frequency is based on a fifth frequency on which the user equipment transmitted the fourth reference signal; wherein a second Doppler shift frequency is determined by the second transmission reception point using the fifth frequency and a sixth frequency on which the fifth reference signal is received by the second transmission reception point.

In certain embodiments, the method further comprises receiving, from the second transmission reception point, a sixth reference signal having an eighth frequency determined based on the second Doppler shift frequency.

In some embodiments, the fourth reference signal and the sixth reference signal are configured as transmission configuration indicators for a control channel transmission to the user equipment.

In various embodiments, the method further comprises using the transmission configuration indicators to decode a control channel reference signal and control channel data.

In one embodiment, the method further comprises using the fourth reference signal and the sixth reference signal for channel state information computation and for providing channel state information feedback.

In certain embodiments, the fourth reference signal and the sixth reference signal are configured for channel state information measurement and feedback by the user equipment.

In some embodiments, the fourth reference signal and the sixth reference signal are configured as transmission configuration indicators for a shared channel transmission to the user equipment.

In various embodiments, the method further comprises using the transmission configuration indicators to decode a shared channel reference signal and shared channel data.

In one embodiment, an apparatus comprises a user equipment, wherein the apparatus further comprises: a receiver that receives, at the user equipment, a first reference signal transmitted from a first transmission reception point on a third frequency; and a transmitter that transmits, from the user equipment, a second reference signal to the first transmission reception point on the third frequency, wherein the third frequency is based on a first frequency on which the first transmission reception point transmitted the first reference signal; wherein a first Doppler shift frequency is determined by the first transmission reception point using the first frequency and a second frequency on which the second reference signal is received by the first transmission reception point.

In certain embodiments, the first Doppler shift frequency is determined based on a difference between the first frequency and the second frequency.

In some embodiments, the second reference signal is configured by the first transmission reception point with the same spatial relation and frequency reference as the first reference signal.

In various embodiments, the receiver receives, from the first transmission reception point, a third reference signal having a fourth frequency determined based on the first Doppler shift frequency.

In one embodiment, the third reference signal is configured by radio resource control signaling as a first quasi-co-location type with respect to the first reference signal.

In certain embodiments, the third reference signal is configured by radio resource control signaling as a quasi-co-location type D with respect to the first reference signal.

In some embodiments, the first quasi-colocation type comprises an average delay, a delay spread, a Doppler shift with frequency offset, a Doppler spread with frequency offset, or some combination thereof.

In various embodiments, the receiver receives, from the first transmission reception point, a frequency difference between the first frequency and the third frequency.

In one embodiment: the receiver receives, at the user equipment, a fourth reference signal transmitted from a second transmission reception point on a seventh frequency; and the transmitter transmits, from the user equipment, a fifth reference signal to the second transmission reception point on the seventh frequency, wherein the seventh frequency is based on a fifth frequency on which the user equipment transmitted the fourth reference signal; wherein a second Doppler shift frequency is determined by the second transmission reception point using the fifth frequency and a sixth frequency on which the fifth reference signal is received by the second transmission reception point.

In certain embodiments, the receiver receives, from the second transmission reception point, a sixth reference signal having an eighth frequency determined based on the second Doppler shift frequency.

In some embodiments, the fourth reference signal and the sixth reference signal are configured as transmission configuration indicators for a control channel transmission to the user equipment.

In various embodiments, the processor uses the transmission configuration indicators to decode a control channel reference signal and control channel data.

In one embodiment, the processor uses the fourth reference signal and the sixth reference signal for channel state information computation and for providing channel state information feedback.

In certain embodiments, the fourth reference signal and the sixth reference signal are configured for channel state information measurement and feedback by the user equipment.

In some embodiments, the fourth reference signal and the sixth reference signal are configured as transmission configuration indicators for a shared channel transmission to the user equipment.

In various embodiments, the processor uses the transmission configuration indicators to decode a shared channel reference signal and shared channel data.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method comprising:
transmitting, from a first transmission reception point TRP, a first reference signal (RS) to a user equipment (E) on a first frequency;
receiving, at the first TRP, a second RS from the UE on a second frequency, wherein the second frequency is based on a third frequency on which the UE received the first RS; and
determining a first Doppler shift frequency using the first frequency and the second frequency.

2. The method of claim 1, wherein the first Doppler shift frequency is determined based on a difference between the first frequency and the second frequency and the second RS is configured by the first TRP with the same spatial relation and frequency reference as the first RS.

3. The method of claim 1, further comprising transmitting, from the first TRP, a third RS having a fourth frequency determined based on the first Doppler shift frequency, wherein the third RS is configured by radio resource control (RRC) signaling as a first quasi-co-location (OCL) type with respect to the first RS.

4. The method of claim 3, wherein the third RS is configured by radio resource control (RRC) signaling as a quasi-co-location (OCL) type D with respect to the first RS.

5. The method of claim 3, wherein the first OCL type comprises an average delay, a delay spread, a Doppler shift with frequency offset, a Doppler spread with frequency offset, or a combination thereof.

6. The method of claim 3, further comprising transmitting, from the first TRP, a frequency difference between the first frequency and the third frequency.

7. The method of claim 1, further comprising:
transmitting, from a second TRP, a fourth RS to the UE on a fifth frequency;
receiving, at the second TRP, a fifth RS from the UE on a sixth frequency, wherein the sixth frequency is based on a seventh frequency on which the UE received the fourth RS; and
determining a second Doppler shift frequency using the fifth frequency and the sixth frequency.

8. The method of claim 7, further comprising transmitting, from the second TRP, a sixth RS having an eighth frequency determined based on the second Doppler shift frequency.

9. The method of claim 8, wherein the fourth RS and the sixth RS are configured as transmission configuration indicators for a control channel transmission to the UE.

10. The method of claim 8, wherein the fourth RS and the sixth RS are configured for channel state information (CSI) measurement and feedback by the UE.

11. The method of claim 8, wherein the fourth RS and the sixth RS are configured as transmission configuration indicators for a shared channel transmission to the UE.

12. The method of claim 1, further comprising providing the first Doppler shift frequency from the first TRP to a second TRP.

13. A method comprising:
receiving, at a user equipment-(UE), a first reference signal (RS) transmitted from a first transmission reception point (TRY) on a third frequency; and
transmitting, from the UE, a second RS to the first TRP on the third frequency, wherein the third frequency is based on a first frequency on which the first TRP transmitted the first RS and has the same spatial relation as the first RS;
wherein a first Doppler shift frequency is determined by the first TRP using the first frequency and a second frequency on which the second RS is received by the first TRP.

14. The method of claim 13, further comprising:
receiving, at the UE, a fourth RS transmitted from a second TRP on a seventh frequency; and
transmitting, from the UE, a fifth RS to the second TRP on the seventh frequency, wherein the seventh frequency is based on a fifth frequency on which the UE transmitted the fourth RS;
wherein a second Doppler shift frequency is determined by the second TRP using the fifth frequency and a sixth frequency on which the fifth RS is received by the second TRP.

15. The method of claim 14, further comprising receiving, from the second TRP, a sixth RS having an eighth frequency determined based on the second Doppler shift frequency, wherein the fourth RS and the sixth RS are configured as transmission configuration indicators for a control channel transmission to the UE.

16. The method of claim 15, further comprising using the transmission configuration indicators to decode a control channel RS and control channel data.

17. The method of claim 15, further comprising using the fourth RS and the sixth RS for channel state information (CSI) computation and for providing CSI feedback.

18. The method of claim 14, further comprising receiving, from the second TRP, a sixth RS having an eighth frequency determined based on the second Doppler shift frequency, wherein the fourth RS and the sixth RS are configured as transmission configuration indicators (TCIs) for a shared channel transmission to the UE, and the method further comprises using the TCIs to decode a shared channel RS and shared channel data.

19. An apparatus for wireless communication, the apparatus comprising:
a processor; and
a memory coupled to the processor, the memory comprising instructions executable by the processor to cause the apparatus to:
transmit, from a first transmission reception point (TRP), a first reference signal (RS) to a user equipment (UE) on a first frequency;
receive, at the first TRP, a second RS from the UE on a second frequency, wherein the second frequency is based on a third frequency on which the UE received the first RS; and
determine a first Doppler shift frequency using the first frequency and the second frequency.

20. The apparatus of claim 19, wherein the first Doppler shift frequency is determined based on a difference between the first frequency and the second frequency and the second RS is configured by the first TRP with the same spatial relation and frequency reference as the first RS.
